(19) United States
(12) Patent Application Publication
(10) Pub. No.: US 2013/0162089 A1
(43) Pub. Date: Jun. 27, 2013

(54) Sintered Magnet Motor

(71) Applicant: Hitachi, Ltd., Tokyo (JP)

(72) Inventors: Matahiro KOMURO, Hitachi (JP); Noriaki HINO, Mito (JP); Yuichi SATSU, Hitachi (JP)

(73) Assignee: HITACHI, LTD., Tokyo (JP)

(21) Appl. No.: 13/727,092

(22) Filed: Dec. 26, 2012

(30) Foreign Application Priority Data
Dec. 27, 2011 (JP) 2011-284704

(51) Int. Cl. H02K 1/02

(52) U.S. Cl. CPC H02K 1/02
USPC 310/156.01

(57) ABSTRACT

A sintered magnet motor includes a rotor, a stator, and coils. Sintered magnets are disposed on the rotor. In the sintered magnet motor, a residual magnetic flux density of each of the sintered magnets is controlled by a magnetic field generated by a coil current.

### BACKGROUND OF THE INVENTION

The present invention relates to a motor using a magnet obtained by sintering a composite material of a Fe alloy and a NdFeB compound which exhibits a high remanence.

An example of a motor using high coercive force magnets and low coercive force magnets which are permanent magnets differing in material composition is disclosed in JP-A-2010-45068. There is description concerning an example in which the high coercive force magnets are NdFeB magnets and the low coercive force magnets are Alnico magnets or FeCrCo magnets. However, there is no description concerning magnetic flux variability obtained by using sintered magnets of one kind and controlling remanent magnetic flux density of them.

There is description of materials in which a hard magnetic material and a soft magnetic material are molded by using fluoride in JP-A-2006-66870. However, there is no description concerning improvement of magnet characteristics brought about by the soft magnetic materials, control of the remanent magnetic flux density using magnetic coupling between the soft magnetic material and the hard magnetic material, and a process for implementing them.

There is description concerning a motor using high resistance magnets in which fluoride and acid fluoride are grown in a layer form in JP-A-2006-238604. There is also description concerning a rotating machine using a soft magnetic material and a hard magnetic material with a fluoride formed. However, there is no description concerning a composite magnet material of a high remanence material and a hard magnetic material, its magnet characteristics improvement, and effects of magnetic flux variability.

There is description of a rotor utilizing a combination of soft magnetic powder and a bond magnet in JP-A-2006-180677. However, there is no description concerning a composite magnet obtained by distributing a soft magnetic material in a hard magnetic material and sintering them.

### SUMMARY OF THE INVENTION

In techniques described in JP-A-2010-45068, JP-A-2006-66870, JP-A-2006-238604, and JP-A-2006-180677, there is no example in which the maximum energy product of a Nd₂Fe₁₄B sintered magnet is increased and the remanent magnetic flux density is made variable, and it is difficult to provide a variable magnetic flux motor using a sintered magnet of one kind.

A sintered magnet motor according to the present invention includes a rotor, a stator, and coils, and sintered magnets are disposed on the rotor. In the sintered magnet motor, a residual magnetic flux density of each of the sintered magnets is controlled by using a magnetic field generated by a coil current.

According to the present invention, it is possible to satisfy reduction of the quantity of rare-earth elements used in rare-earth permanent magnets, increase of coercive force, and increase of the maximum energy product, and the quantity of magnets to be used can be reduced. This contributes to reduction of sizes and weights of various products using magnets.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram of a sintered magnet motor according to the present invention;

FIG. 2 is a configuration diagram for magnetic flux control according to the present invention; and

FIG. 3 shows a demagnetization curve of a sintered magnet according to the present invention.

### DESCRIPTION OF THE EMBODIMENTS

Permanent magnets using rare-earth elements such as rare-earth iron boron represented by Nd₂Fe₁₄B sintered magnets are used in various magnetic circuits. For permanent magnets used at high temperatures or in environments of great magnetization, it is indispensable to add heavy rare-earth elements besides light rare-earth elements. It is an extremely important subject from the viewpoint of the earth resource protection to reduce the use quantity of rare-earth elements including heavy rare-earth elements. In the conventional technique, reduction of the use quantity of rare-earth elements lowers the maximum energy product or coercive force and its application is difficult. It is a subject in magnet materials to satisfy the reduction of use quantity of rare-earth elements, increase of coercive force, and increase of the maximum energy product.

Motors using interior permanent magnet rotors which utilize the magnet torque and reluctance torque in order to enhance the motor efficiency are commercialized. As the magnetic flux leaking from the permanent magnet becomes high, the magnet torque becomes large. Since the leak magnetic flux of the magnet is high, however, the iron loss of the stator becomes large, resulting in a lowered motor efficiency. In order to suppress the efficiency lowering, sintered magnets in which the magnetic flux of NdFeB sintered magnets can be controlled to vary are used. As for a NdFeB sintered magnet material used in the present invention, the content of the rare-earth elements can be reduced and the remnant magnetic flux density can be varied by the applied magnetic field, resulting in an increased motor efficiency.

In the present invention, a composite of FeM powder (M is a transition element, and iron and rare-earth elements are excluded) such as FeCo powder having a high remanence and NdFeB powder is sintered. Saturation magnetization of the FeM powder is greater than saturation magnetization of the NdFeB powder. Since FeM crystal after sintering is apt to reverse in magnetization if kept singly, the reversal is prevented by magnetic coupling with NdFeB crystal. For obtaining magnetic coupling, it is necessary to increase the crystal magnetic anisotropy energy of the NdFeB crystal which is in contact with FeM crystal via the grain boundary and it is also necessary that FeM crystal and NdFe crystal in the vicinity of the grain boundary are magnetically coupled.

In the present invention, FeM crystal having saturation magnetization which is higher than that of Nd₂Fe₁₄B is an alloy having a remanence in the range of 1.5 T to 2.8 T. There is no restriction on its composition as long as the remanence is in the range of 1.5 T to 2.8 T, and the FeM crystal may contain rare-earth elements, semimetallic elements, and various metallic elements. Since the remanence is higher than that of Nd₂Fe₁₄B, it becomes possible to increase the residual magnetic flux density by magnetically coupling the FeM crystal with crystal grains of Nd₂Fe₁₄B. The FeM crystal and the Nd₂Fe₁₄B crystal are in contact with each other via a heavy rare-earth element uneven distribution phase. This heavy rare-earth element uneven distribution phase contains fluorine, oxygen, and carbon.

A sintering auxiliary material is used to make the quantity of the liquid phase at the sintering temperature satisfactory, enhance the wettability between the liquid phase and crystal grains of FeCo crystal and crystal grains of Nd₂Fe₁₄B and make the density after the sintering high. Since the fluorine containing phase easily reacts with a phase having a high rare-earth element concentration, the quantity of the liquid phase decreases. As a result, the density after the sintering lowers and the coercive force also lowers. In order to prevent the density and coercive force from decreasing, for example, a Fe-70% Nd alloy powder is added as the sintering auxiliary material.

In addition, a magnetic field is applied at a temperature in the vicinity of the Curie temperature or above of Nd₂Fe₁₄B in a provisional molding process before sintering. As a result, the magnetic field application effect can be implemented in a temperature range in which magnetization of the FeM powder becomes greater than magnetization of Nd₂Fe₁₄B. Anisotropy is added to the FeCo powder selectively, and deacidification using a fluoride and growth of the FeCo regular phase are promoted. As for a part of the regular phase, lattice distortion is introduced after the sintering, and consequently lattices are deformed near an interface and anisotropic energy increases.

As a manufacturing technique, fluoride solution processing is used to make distribution of a heavy rare-earth element uneven. The solution used in the fluoride solution processing contains an anion component of 100 ppm order or below. In processing on a material containing a large amount of rare-earth elements, therefore, a part of the surface of the processed material is corroded or oxidized. In the present invention, ferromagnetic alloy powder of at least two kinds including NdFeB powder and FeM powder is used for the sintered magnet. Furthermore, a material subject to the fluoride solution processing is set to be FeM powder having high corrosion resistance to prevent corrosion or oxidization caused by the fluoride solution processing. Furthermore, in general, the FeM crystal is small in coercive force if it is kept singly. Therefore, it contributes to increase of coercive force and reduction of the use quantity of the rare-earth elements to make uneven distribution of rare-earth elements, especially of a heavy rare-earth element near grain boundaries.

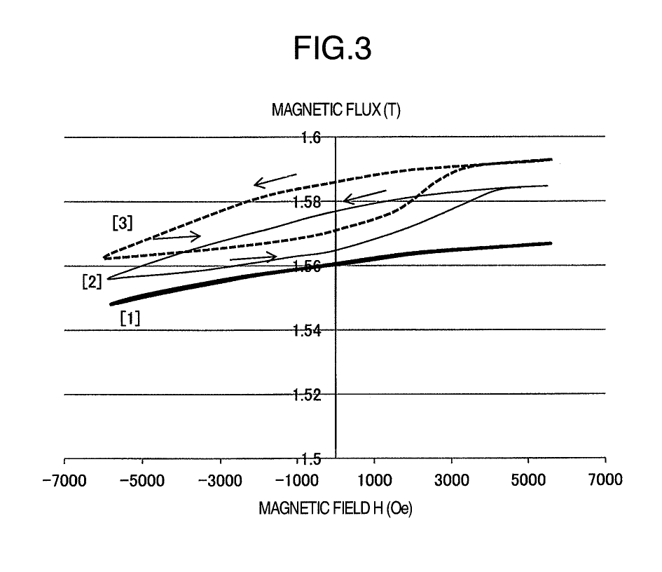

The change of the residual magnetic flux density of the sintered magnet is reversible in the first quadrant (where the magnetic field and the magnetic flux are positive) and the second quadrant (where the magnetic field is negative and the magnetic flux is positive) of a demagnetization curve which indicates the relation between the residual magnetic flux density and the magnetizing field. It means that the magnetic flux of the sintered magnet is variable in a magnetic field which is smaller than the magnetizing field of RE₂FE₁₄B (RE is a rare-earth element). It is possible to increase the motor efficiency by using such a variable magnetic flux phenomenon in a rotating machine. By the way, details of the demagnetization curve will be described later with reference to FIG. 3.

A sintered magnet according to the present invention is inserted in an interior permanent magnet rotor. After magnetizing using a winding, a value of a current let flow through a stator winding is controlled by an inverter while measuring an induced voltage. The rotor is rotated by a suitable current waveform.

If a high torque is required, then a current capable of applying a magnetic field in the first quadrant of the demagnetization curve is let flow and thereby the residual magnetic flux density of the sintered magnet is made large to strengthen the magnetic flux of the sintered magnet. If a low torque is required, then a current capable of applying a magnetic field in the second quadrant of the demagnetization curve is let flow and thereby the residual magnetic flux density of the sintered magnet is made small to weaken the magnetic flux of the sintered magnet.

In the above-described variable magnetic flux motor, the magnetic flux of the sintered magnet can be increased/decreased by controlling the inclination of magnetization of the FeM alloy which is a high magnetization phase constituting the composite magnet. The used sintered magnet is a kind of the composite magnet. As the use ratio of the FeM alloy increases, the use quantity of rare-earth elements can be reduced. Since the magnet is a sintered magnet, there is no problem of heat resistance or insufficient magnetic flux unlike the bond magnet. The variable magnetic flux motor has such features.

### EXAMPLE 1

The Fe-10% Co powder is made by using the water atomizing method, and its average grain diameter is 10 μm. It contains oxygen in the vicinity of the surface. If the oxygen quantity is at least 500 ppm, acid fluoride grows after forming fluoride on the surface of the Fe-10% Co powder. Such an acid fluoride is represented as RExOyFz (where RE is a rare-earth element, O is oxygen, F is fluoride, and x, y and z are positive integers). And the acid fluoride contains inevitable elements such as carbon and nitrogen as impurities. The acid fluoride is formed by applying an alcohol solution containing fluoride and oxygen to the surface of water atomized powder, heating it to a temperature in the range of 350 to 900° C., and then cooling it at a rapid rate of 10° C./second.

The atomized powder with acid fluoride applied and the NdFeB powder are mixed with a mixture ratio of 2:8. Then, molding in a magnetic field (0.5 t/cm², 10 kOe) is conducted at the room temperature. In addition, provisional molding is conducted in a magnetic field at the Curie temperature or above of the NdFeB powder. By conducting provisional molding in a magnetic field (0.5 t/cm², 20 kOe) at a temperature of 350° C., only the atomized powder with acid fluoride applied is aligned in parallel to the magnetic field application direction and the easy direction of magnetization of the atomized powder with acid fluoride applied and the hard direction of magnetization of the NdFeB powder become substantially parallel to each other. After the provisional molding, hydrostatic molding may be executed. The remanence of the atomized powder with acid fluoride applied is 2.1 T at 20° C., and the FeCo regular phase grows on an interface with fluoride or acid fluoride.

A provisional compact subjected to the provisional molding process is heated in an inert gas at 1,050° C. for three hours and sintered. After the sintering, the compact is heated at 500° C. for one hour and subject to rapid quench to produce a sintered magnet. The residual magnetic flux density of the sintered magnet is 1.65 T and the maximum energy product of the sintered magnet is 64 MGOe.

Features of the sintered magnet in the present example are as follows.

1) The ferromagnetic phases constituting the magnet are the RE₂Fe₁₄B phase and the FeM alloy phase (where RE is a rare-earth element, and M is a transition element other than iron and rare-earth elements). Magnetic coupling is perceived between these ferromagnetic phases. By way of illustration of magnetic coupling, the demagnetization curve is not the sum of the plurality of individual ferromagnetic phases and a change of the curve shape caused by magnetic coupling is perceived.

2) The volume ratio of the FeM alloy (ferromagnetic phase which does not contain rare-earth elements) to the whole of the sintered magnet is in the range of 0.1 to 50%. If the volume ratio is less than 0.1%, a remarkable effect of compounding the FeM alloy is not perceived. If the volume ratio exceeds 50%, magnetic coupling becomes weak and the coercive force decreases. By the way, for preventing the decrease of the coercive force, it is effective to form an oxide or a Mn compound which exhibits ferrimagnetism other than RE₂FE₁₄B (where RE is a rare-earth element, Fe is iron, and B is boron) near the grain boundaries and form a regular phase on peripheral sides of crystal grains of the FeM alloy.

3) In the second quadrant of the demagnetization curve, magnetization changes irreversibly.

4) The coercive force is at least 10 kOe.

Among the features, the irreversible change of the magnetization of the sintered magnet with respect to the magnetic field corresponds to inclination of magnetization of a partial ferromagnetic phase from the initial magnetization direction. The FeM alloy having magnetization inclined from the initial magnetization direction is in a state in which magnetization reversal is not apt to occur because of magnetic coupling with RE₂FE₁₄B. If predetermined conditions are satisfied depending upon the temperature rise, intensity of the demagnetization field, and the direction of the magnetic field, however, the magnetization inclines easily and the magnetic flux of the sintered magnet decreases in a magnetic field which is smaller than the coercive force.

The residual magnetic flux density which has decreased is equivalent to the magnetization rotation of the FeM alloy. If a magnetic field parallel to the magnetization direction is applied in the first quadrant, restoration is made with a magnetic field smaller than the initial magnetization field of Fe₂Fe₁₄B. In other words, if the magnetization of the FeM alloy is substantially parallel to the magnetization of Fe₂Fe₁₄B, then the residual magnetic flux density is high. Since the magnetization inclines with the angle difference in the range of 1 to 180 degrees, the residual magnetic flux density increases/decreases. Even if the magnetization of the FeM alloy becomes opposite locally in direction to the magnetization of RE₂Fe₁₄B, the coercive force of RE₂Fe₁₄B adjacent to crystal grains of the FeM alloy increases because of the uneven distribution of the heavy rare-earth element, and consequently magnetization reversal of RE₂Fe₁₄B which is the main phase does not occur and the magnetization of the FeM alloy easily becomes substantially parallel to the magnetization of RE₂Fe₁₄B due to a magnetic field in the initial magnetization direction component. If the coercive force of the sintered magnet is less than 10 kOe, then irreversible demagnetization becomes apt to occur and it becomes difficult to control the magnetic flux. Therefore, it becomes necessary that the coercive force of the sintered magnet is at least 10 kOe.

By the way, “the residual magnetic flux density which has decreased is equivalent to the magnetization rotation of the FeM alloy” has the following meaning. The FeM alloy magnetically couples with RE₂Fe₁₄B. However, its coupling magnetic field is smaller than the coercive force of RE₂Fe₁₄B. Therefore, the direction of magnetization of the FeM alloy is changed more easily by a magnetic field of a component opposite to the initial magnetization direction of RE₂Fe₁₄B as compared with RE₂Fe₁₄B. A magnetostatic action exerts between the magnetization of the FeM alloy and the magnetization of RE₂Fe₁₄B to align them with the initial magnetization direction. When a magnetic field opposite to the magnetization direction is applied, the magnetization of the FeM alloy rotates to the direction of the opposite magnetic field earlier than RE₂Fe₁₄B. This magnetization rotation decreases the residual magnetic flux density of the sintered magnet.

The change of the residual magnetic flux density as described above means that it is reversible in the first and second quadrants and the magnetic flux of the sintered magnet is variable in a magnetic field which is smaller than the initial magnetization magnetic field of RE₂Fe₁₄B. It is possible to increase the efficiency of a rotating machine by using such a variable magnetic flux phenomenon of the sintered magnet in the rotating machine.

A sintered magnet in the present example is inserted in an interior permanent magnet rotor. After initial magnetization using a winding, a value of a current let flow through a stator winding is controlled by an inverter while measuring an induced voltage. The rotor is rotated by a suitable current waveform. If a high torque is required, then a current capable of applying a magnetic field in the first quadrant of the demagnetization curve is let flow and thereby the residual magnetic flux density of the sintered magnet is made large to strengthen the magnetic flux of the sintered magnet. If a low torque is required, then a current capable of applying a magnetic field in the second quadrant of the demagnetization curve is let flow and thereby the residual magnetic flux density of the sintered magnet is made small to weaken the magnetic flux of the sintered magnet.

The above-described variable magnetic flux rotating machine has features described below. 1) The direction of the magnetization of the FeM alloy which is the high magnetization phase constituting a composite magnet is controlled in the range of 1 to 180 degrees from the magnetization of RE₂Fe₁₄B to increase/decrease the magnetic flux of the sintered magnet. 2) Sintered magnets to be used are only one kind of a composite magnet. 3) As the use rate of the FeM alloy increases, the use quantity of the rare-earth elements can be reduced. 4) Since the magnet is a sintered magnet, there isn't the problem of heat resistance and magnetic flux insufficiency unlike the bond magnet.

In the present example, an element M of the FeM alloy is a transition element other than iron and rare-earth elements. Especially, a 3d or 4d transition element is desirable. In the sintered magnet, a multi-layer structure including a FeM alloy irregular phase, a FeM alloy regular phase, an acid fluoride, a NdFeB alloy phase having uneven distribution of a heavy rare-earth element, and a NdFeB alloy phase from the center of crystal grains of the FeM alloy toward outside is formed.

### EXAMPLE 2

In the sintered magnet in the present example, FeM crystal having a remanence which exhibits a value greater than a value of that of Nd₂Fe₁₄B crystal is formed inside and anisotropy is perceived in the arrangement of FeM crystal grains. This sintered magnet has a feature that the residual magnetic flux density is larger and the use quantity of the rare-earth elements is less as compared with a sintered magnet having only the Nd₂Fe₁₄B crystal as the main phase. A part of its typical demagnetization curve is shown in FIG. 3. In FIG. 3, the abscissa axis represents the magnetic field H (Oe) and the ordinate axis represents the residual magnetic flux density (T).

[1] indicates a demagnetization curve of a Nd₂Fe₁₄B sintered magnet. [2] indicates a demagnetization curve of a Nd₂Fe₁₄B/FeCo composite sintered magnet with FeCo (having a remanence of 1.9 T) added by 3%. [3] indicates a demagnetization curve of a Nd₂Fe₁₄B/FeCo composite sintered magnet with FeCo (having a remanence of 2.0 T) added by 5%. In the vicinity of the interface between FeCo and Nd₂Fe₁₄B in the sintered magnet [2] and the sintered magnet [3], Tb is distributed unevenly. The coercive force is greater than that of the sintered magnet [1].

In the demagnetization curve of the sintered magnet [1], magnetic flux in the demagnetizing field in which the magnetic field becomes negative from positive substantially coincides in value with magnetic flux in the magnetizing field in which the magnetic field becomes positive from negative. On the other hand, in the sintered magnet [2] and the sintered magnet [3], a magnetic field area where a value of magnetic flux in the demagnetizing field does not coincide with a value of magnetic flux in the magnetizing field and there is a difference in magnetic flux is perceived.

The magnetic flux of the magnetized sintered magnet is decreased by the demagnetizing field. In the sintered magnet [2] and the sintered magnet [3], magnetization of a part inclines and the magnetization remains inclined even if a magnetic field is applied to the positive side and a low magnetic flux is brought about. Furthermore, the value of the residual magnetic flux density in the case where a magnetic field is applied from negative to positive differs from the value of the residual magnetic flux density in the case where a magnetic field is applied from positive to negative. If a low residual magnetic flux density is brought about due to inclination of magnetization, the residual magnetic flux density is substantially restored (the value of the residual magnetic flux density returns to a value before reduction) by applying a magnetic field in the range of 3 to 5 kOe to the positive side. The restored residual magnetic flux density is decreased by a demagnetizing field applied to the negative side, and remains to be a low residual magnetic flux density until a magnetic field is applied to the positive side. However, the magnetic flux is restored by applying a sufficient magnetic field to the positive side. Therefore, reversible control of the residual magnetic flux density is made possible by the positive side magnetic field.

In the sintered magnet [2] and the sintered magnet [3], the value of the residual magnetic flux density can be controlled by a negative magnetic field or a positive magnetic field. As the volume ratio of the FeM crystal becomes large, it is possible to make the width of the residual magnetic flux density which can be controlled large. In the sintered magnet [2] and the sintered magnet [3], the residual magnetic flux density is variable in a width of 0.1 to 0.15 T. It is possible to increase the variable width of the residual magnetic flux density by increasing the addition quantity of FeCo. For example, if FeCo is added by 20%, control is possible in a residual magnetic flux density width of 0.3 T.

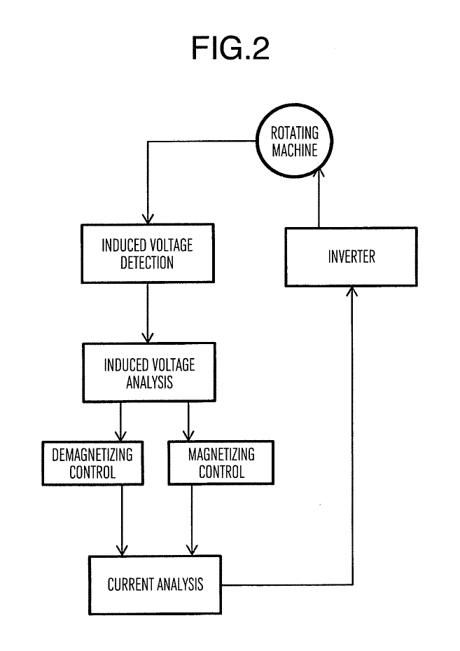

FIG. 2 shows a configuration of a control system for controlling the variable magnetic flux in the present example. The magnetization state of the sintered magnet can be known by detecting a waveform of an induced voltage of the rotating machine and analyzing the induced voltage waveform. Relations between the magnetization state and the coil current magnetic field are stored as a database. Therefore, a decision is made whether the first quadrant is passed through with the magnetic field set to the positive side or whether the magnetic flux is decreased by a demagnetizing field on the negative side with parameters such as a required torque, efficiency, and the number of revolutions added. In order to generate a magnetic field to be applied to the sintered magnet in the rotor by using a current in controlling the magnetic field for demagnetizing or magnetizing, the current waveform is analyzed by a current analysis and a current let flow through the coil of the stator is controlled by an inverter.

A value of the residual magnetic flux density or the magnet surface magnetic field obtained when a magnetic field of at least 50 kOe is applied is taken as one of references. Supposing that the magnetization of the FeCo alloy is parallel to the magnetization of Nd₂Fe₁₄B at this value, a relation between a value of decrease of the magnet surface magnetic field and an inclination angle of the magnetization of the FeCo alloy can be analyzed. The induced voltage waveform is analyzed by using the analysis. On the basis of its result, parameters of a making current waveform are determined. Owing to such control, the magnetic flux of the sintered magnet is changed to correspond to various running states while maintaining a high efficiency.

For the above-described magnetic flux control of the sintered magnet, the rotating machine needs a configuration obtained by suitably setting up the induced voltage detection, induced voltage analysis, demagnetizing control, magnetizing control, current analysis, and the inverter.

### EXAMPLE 3

A Fe-30% Co alloy is foil-shaped powder fabricated by using the molten metal rapid quench method. The Fe-30% Co alloy subjected to high-frequency dissolution in an inert gas environment is injected to surface of a copper roll. As a result, plate like or foil shaped powder which is 10 μm in thickness and 100 μm in average diameter of major axis is obtained. Even if various metallic elements other than Fe and Co or semimetallic elements are contained to ensure magnetic characteristics, it becomes possible to make saturation magnetization higher than that of Nd₂Fe₁₄B crystal if the content is less than 20 atomic %. The maximum energy product after sintering can be made larger as compared with the case where the FeCo alloy is not used.

The Fe-30% Co alloy powder having a remanence of 2.1 T and the Nd₂Fe₁₄B powder having a remanence of 1.5 T are mixed at a mixture ratio of 1:9. After provisional molding at the room temperature, provisional molding is conducted at 400° C. and anisotropy is added to the orientation of the FeCo alloy powder. The FeCo alloy powder is oriented to have its major axis in parallel to the magnetic field direction. The magnetization curve of the FeCo alloy powder in the magnetic field application direction differs from that in its perpendicular direction. The provisional compact is immersed in DyF alcohol solution. After heating and drying, the provisional compact is heated to 1100° C. and sintered. The provisional compact is re-heated to 500° C. and subject to rapid quench to fabricate a sintered magnet. The residual magnetic flux density is 1.65 T and the coercive force is 25 kOe.

In the case where the NdFeB—FeCo sintered magnet having Nd₂Fe₁₄B and the FeCo alloy as the main phase fabricated in this way is glued to a laminated electromagnetic steel plate, laminated amorphous or dust iron to fabricate a rotor, the magnet is inserted in a suitable position beforehand.

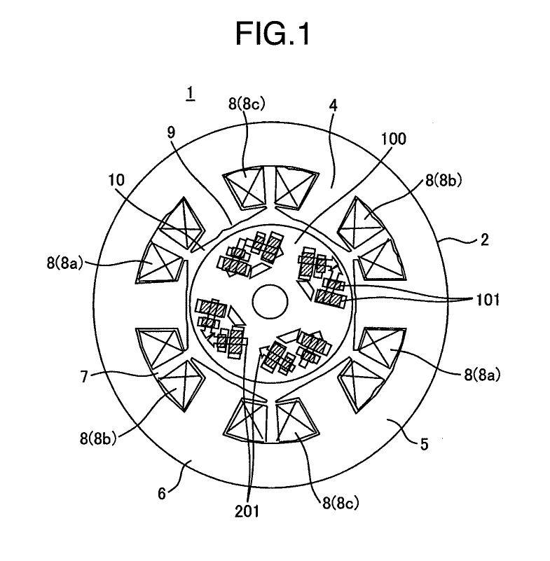

FIG. 1 shows a schematic diagram of a section perpendicular to the axis direction of a motor 1. The motor 1 includes a rotor 100 and a stator 2. The stator 2 includes a core back 5 and teeth 4. A coil group composed of coils 8 (U-phase windings 8a, V-phase windings 8b, and W-phase windings 8c of three-phase windings) is inserted into coil insertion positions 7 between two teeth 4 adjacent to each other. A rotor insertion part 10 where the rotor is to be placed is secured between a tip part 9 and a shaft center, and the rotor 100 is inserted into this position. Sintered magnets 101 are inserted on a periphery side of the rotor 100. Arrows indicated overlapping the sintered magnets are initial magnetization directions 201 of the sintered magnets.

The magnetic flux of the sintered magnet subjected to initial magnetization is decreased by the demagnetization field and magnetization of a part of the FeCo alloy inclines. Even if a magnetic field is applied to the positive side, the magnetization remains inclined resulting in low magnetic flux. The value of the residual magnetic flux density in the case of application of a magnetic field from negative to positive differs from that in the case of application of a magnetic field from positive to negative. If a low residual magnetic flux density is caused by inclination of magnetization, the residual magnetic flux density is substantially restored by applying a magnetic field in the range of 3 to 5 kOe to the positive side. The restored residual magnetic flux density is decreased by a demagnetizing field applied to the negative side, and remains to be a low residual magnetic flux density until a magnetic field is applied to the positive side. However, the magnetic flux is restored by applying a sufficient magnetic field to the positive side. Therefore, reversible control of the residual magnetic flux density is made possible by the positive side magnetic field.

The value of the residual magnetic flux density can be controlled by a negative magnetic field or a positive magnetic field. As the volume ratio of the FeCo alloy becomes large, it is possible to expand the width of the residual magnetic flux density which can be controlled. In the present example, the residual magnetic flux density is variable in the width of 0.2 T. The variable width of the residual magnetic flux density can be expanded by increasing the addition quantity of FeCo. If FeCo is added by 20%, the residual magnetic flux density can be controlled in a residual magnetic flux density width in the range of 0.3 to 0.4 T. If the variable width of the residual magnetic flux density is less than 0.01 T, it is difficult to confirm the efficiency improvement effect of the motor. For attaining a higher efficiency of the motor, it is desirable that the variable width of the residual magnetic flux density is in the range of 0.01 to 0.5 T. If 0.5 T is exceeded, then the gradient of the demagnetization curve becomes large and it becomes difficult to control the magnetic flux by using the coil current.

If a high torque is required, then a current is let flow through the coil 8 and a magnetic field formed by the coil current is applied in a direction opposite to the initial magnetization direction of the sintered magnet and thereby the residual magnetic flux density of the sintered magnet is made large to strengthen the magnetic flux of the sintered magnet. If a low torque is required, then a current is let flow through the coil 8 and a magnetic field formed by the coil current is applied in the same direction as the initial magnetization direction of the sintered magnet and thereby the residual magnetic flux density of the sintered magnet is made small to weaken the magnetic flux of the sintered magnet.

### EXAMPLE 4

Alkaline mineral oil with ion and cobalt ions introduced therein is heated to 200° C. Mineral oil containing fluorine is injected. After agitation, rapid quench is conducted at a cooling rate in the range of 5 to 20° C./second. Fe—Co—F powder having an average grain diameter in the range of 1 to 1,000 nm is obtained by washing after the quench. The main crystal structure of the powder is a mixture of the bcc and bct structures. By heating the powder subjected to the quench in the range of 200 to 500° C., partial crystal is made regular and crystal magnetic anisotropy increases.

As for magnetic characteristics of the made powder, the saturation magnetization is 230 emu/g, anisotropic magnetic field is 50 kOe, and the Curie temperature is 720° C. The powder is classified, and compression molding is conducted on powder having a grain diameter in the range of 20 to 50 nm in a magnetic field. As a result, a permanent magnet having a maximum energy product in the range of 15 to 70 MGOe is obtained. The maximum energy product depends upon the volume of a used binder, the orientation property of the powder, and the grain diameter of the powder.

It is perceived that the Fe—Co—F powder inevitably contains carbon, oxygen, hydrogen, nitrogen, boron, and chlorine. A part of these elements is contained in crystal of bcc or bct. The composition for implementing the above-described magnetic characteristics is in the range of Fe-1 to 50% Co-1 to 35% F. In the temperature range of 500 to 900° C., phase modification from a metastable phase to a stable phase is conducted. A part of fluorine may be carbon, oxygen, hydrogen, nitrogen, boron, and chlorine. However, it is desirable that fluorine has a high concentration among these elements. For making the coercive force equal to at least 10 kOe, it is desirable to use the powder in a temperature range in which a phase change from the metastable phase to the stable phase is not caused.

As for a demagnetization curve of the FeCoF permanent magnet, the residual magnetic flux density changes by 0.1 to 0.5 T in a magnetic field in the range of ±10 kOe depending upon the history of magnetic field application. The variable magnetic flux of the motor can be implemented by utilizing this change of the residual magnetic flux density.

### EXAMPLE 5

Grains of a Fe-90 wt % Co alloy are subject to surface processing using a DyF solution, and mixed with an alcohol solution with Nd₂Fe₁₄B powder and Cu nano-grains dispersed. An average grain diameter of grains of the Fe-90 wt % Co alloy is 50 nm. A film thickness of fluoride subjected to the surface processing using the DyF solution is 1 nm. An average powder diameter of the Nd₂Fe₁₄B powder is 4 μm. A grain diameter of the Cu nano-grains is 30 nm. Mixture is conducted to cause the grains of the Fe-90 wt % Co alloy have 10 volume %, the Nd₂Fe₁₄B powder to have 85 volume %, and the Cu nano-grains to have 4 volume %. After orientation in a magnetic field, sintering is conducted at 1,000° C. and Cu and Dy are distributed unevenly in the vicinity of the grain boundary. Uneven distribution of Cu increases the coercive force. If a DyF film is formed by applying a DyF solution to the surface of Cu nano-grains and drying the Cu nano-grains, then the coercive force further increases.

Features of the magnet made in the present example are that the grain boundary cover rate is in the range of 20 to 90%, Dy is distributed unevenly in the vicinity of the interface between the FeCo alloy and the Nd₂Fe₁₄B crystal grains, and fluorine is observed on the crystal grain boundary. If the grain boundary cover rate is less than 5%, then the coercive force lowers and the maximum energy product decreases. For implementing coercive force of 20 kOe with a Dy use quantity of 2 wt %, it is necessary to form a fluorine containing grain boundary phase and a Dy unevenly distributed layer having a grain boundary cover rate of Cu in the range of 20 to 90%. Cu covered on grain boundary is Cu—Nd alloy, Cu—Nd—Dy alloy, Cu—Nd—Dy—O alloy, or Cu—Nd—Dy—O—F alloy.

The maximum energy product is increased due to an effect of increased saturation magnetization by mixing with the Fe-90% Co alloy. For making the use quantity of Dy less than 2 wt % with a maximum energy product of at least 40 MGOe and a coercive force of at least 20 kOe, it becomes necessary to mix with powder of a FeCo alloy or Co alloy covered by a DyF film, at a ratio of at least 2 to 30 volume % and add a grain boundary coverage material such as Cu.

As for a demagnetization curve of the magnet material containing FeCo powder by 10 volume % in the present example, the residual magnetic flux density changes by 0.01 to 0.2 T in a magnetic field in the range of ±10 kOe depending upon the history of magnetic field application. The variable magnetic flux of the motor can be implemented by utilizing this change of the residual magnetic flux density.

### EXAMPLE 6

A (Nd, Dy)₂Fe₁₄B sintered magnet is heated to 150° C. in an Ar atmosphere, and exposed to a dissociation gas of XeF₂. As a result, the rare-earth rich phase on the grain boundary is mainly fluorinated. The product differs depending upon the fluorination time, temperature, and gas pressure. Fluorine diffuses along the grain boundary by fluorinating at 150° C. for 10 minutes. Composition distribution of elements such as various metallic elements and oxygen added to the sintered magnet in the vicinity of the grain boundary is changed by the introduction of fluorine. Fluorides or acid fluorides such as NdOF, NdF₂ and NdF₃ are grown on the grain boundary by the introduction of fluorine. Dy distributes unevenly on the grain boundary side of main phase crystal grains than the grain boundary center. Added elements such as Cu and Al also distribute unevenly in the vicinity of the interface to main phase crystal grains than the grain boundary center abundant in fluorine. The coercive force is increased by 2 to 15 kOe by such a change of the composition distribution brought about by the introduction of fluorine.

Further prolonging the fluorinating time, the sintered magnet is exposed to XeF₂ decomposition generation gas at 150° C. for a time period in the range of 20 to 30 minutes. As a result, a Fe rich phase in which a part of a main phase (Nd, Dy)₂Fe₁₄B is a rare-earth fluoride and a bcc or bct structure grows. In this rich phase, the residual magnetic flux density increases higher than the saturation magnetization. The Fe rich phase and (Nd, Dy)₂Fe₁₄B contain various added elements and inevitable impurities. And magnetic coupling between the Fe rich phase and (Nd, Dy)₂Fe₁₄B is perceived. Since the Fe rich phase is grown by coupling between a rare-earth element and fluorine, a rare-earth fluoride or a rare-earth acid fluoride is perceived on a part of an interface of the Fe rich phase. If the fluorination time becomes further longer, then the volume rate of the Fe rich phase of bct or bcc increases and the residual magnetic flux density increases, but the coercive force tends to decrease.

The reason why the maximum energy product is increased by the introduction of fluorine is that a high magnetization phase having magnetization of at least 160 emu/g such as the Fe rich phase having a high concentration ratio which is higher than 2:14 in the ratio of rare-earth elements to Fe in addition to a change in distribution of grain boundary composition. The introduction quantity of fluorine in the sintered magnet is in the range of 0.01 to 10 atomic percent. If the fluorine quantity is less than 0.01 atomic percent, the composition distribution in the vicinity of surface can be changed. However, it does not reach a quantity required to change the grain boundary composition of the whole magnet having a thickness in the range of 0.1 to 10 mm. If the fluorine quantity exceeds 10 atomic percent, then crystal grains of the Fe rich phase become gross and the coercive force decreases.

A feature of the magnet material in the present example is that average concentration distribution (a concentration including one hundred crystal grains and their grain boundaries) in the depth direction of an element other than fluorine does not change from that obtained before the introduction of fluorine except the extreme surface. The rare-earth rich phase on the grain boundary is fluorinated by the introduction of fluorine. The composition distribution, crystal structure, phase configuration, and uneven distribution width in the vicinity of grain boundary where fluorine is introduced are changed by aging heat treatment or diffusion heat treatment of transition metal on a higher temperature side than fluorination processing temperature after the fluorination.

As another feature, the ratio of the Fe rich phase to the main phase volume in which the Fe rich phase is formed becomes large as the position approaches the surface of the sintered magnet. A gradient of the Fe rich phase volume rate in the range from the surface of the sintered magnet toward the inside is perceived. Furthermore, fluoride grows abundantly on the surface of the sintered magnet. Uneven distribution of the heavy rare-earth element is also remarkable on the surface side of the sintered magnet. Furthermore, fluorine is diffused within Nd₂Fe₁₄B crystal grains which are the main phase. Intermetallic compounds located on the Fe rich side as compared with a stoichiometric composition of Nd₂Fe₁₄B and a Fe rich phase having the bcc or bct structure grow in a partial main phase. Lattice matching is perceived on a part of an interface between the Fe rich phase having the bcc or bct structure and the main phase. The volume rate of the Fe rich phase is desirable in the range of 0.01 to 50% in a part within 100 μm from the magnet surface. If the volume rate of the Fe rich phase is less than 0.01%, the coercive increasing effect brought about by fluorination becomes less than 0.5 kOe. If the volume rate of the Fe rich phase exceeds 50%, then decrease of the coercive force becomes remarkable and thermal demagnetization is apt to occur and consequently application becomes difficult.

By adopting the technique in the present example, it is possible to diffuse fluorine in the rare-earth rich phase of the sintered magnet selectively by use of gas or a solution containing fluorine such as XeF₂ gas and causing uneven distribution various elements added to the NdFeB sintered magnet in the vicinity of grain boundaries by aging quench heat treatment. The quantity of reacting fluorine in Nd₂Fe₁₄B which is the main phase differs from that in the rare-earth rich phase which is the grain boundary phase. The reaction ratio between the main phase and the grain boundary phase is in the range of 1:2 to 1:10,000. If the reaction ratio to the grain boundary phase becomes small, then stable fluoride or acid fluoride is formed on the surface of the sintered magnet and reaction or diffusion of fluorine does not advance.

In the present example, XeF₂ is used. However, similar effects can be confirmed by using a fluoride which generates fluorine containing gas other than XeF₂, or fluorine plasma such as radical fluorine or fluorine ion. Fluorination reaction can be stabilized by using a solution which is a mixture of a fluorination agent and mineral oil or alcohol. Furthermore, ammonium fluoride (NH₄F) or ammonium acid fluoride (NH₄F.HF) can also be used. A fluorination agent which is a mixture of any of these fluorination agents and XeF2 may also be used. If chlorine, bromine, phosphorus, oxygen, or boron is mixed with any of these fluorination agents, a similar effect can be obtained.

Not only in Nd₂Fe₁₄B sintered magnets such as (Nd, Dy)₂Fe₁₄B sintered magnets or (Nd, Pr, Dy)₂Fe₁₄B sintered magnets, but also in a composite sintered magnets of Sm₂Co₁₇, FeCo, and Nd₂Fe₁₄B, sintered magnets having a heavy rare-earth element distributed unevenly, Nd₂Fe₁₄B thin film or Nd₂Fe₁₄B hot molding magnets, MnAl, MnBi, ferrite, AlNiCo and FeCo magnets, increase of the coercive force, increase of the residual magnetic flux density, and increase of the maximum energy product can be confirmed. As for these materials, it is possible to further increase the coercive force by executing grain boundary diffusion processing of various elements before and after the process of executing fluorination processing. It contributes to reduction of rare metals.

It is desirable that the powder diameter of XeF₂ is in the range of 0.1 to 1,000 μm. If the powder diameter exceeds 1,000 μm, unevenness of the fluorine concentration is apt to occur, the grain boundary composition and structure on the surface or in the inside of the magnet become uneven, and consequently the magnet characteristics do not stabilize. If the powder diameter is less than 0.1 μm, then decomposition of XeF₂ is apt to occur and control of the processing time and temperature becomes difficult.

### EXAMPLE 7

Nd₂Fe₁₄B powder and Fe powder are mixed with a volume ratio of 8:2. Then, molding is conducted in a magnetic field. Fluorine is introduced by fluorine gas processing. A part of the Fe powder becomes an iron fluorine (Fe—F) alloy having a bct structure containing fluorine by 0.1 to 15 atom 5 as a result of the introduction of fluorine. A magnetic field is applied again to make the c-axis direction of the Nd₂Fe₁₄B powder parallel to the c-axis direction of the Fe—F alloy in average. A sintering auxiliary agent is added and sintering is conducted in the range of 600 to 900° C. If sintering is conducted on the temperature side higher than 900° C., fluorine in the Fe—F alloy is eliminated. Therefore, it is necessary to conduct sintering on the low temperature side. Fluorine is perceived within the crystal of Nd₂Fe₁₄B as well. Even if boron is partially replaced by fluorine, the magnetic characteristics can be improved.

For preventing the elimination of fluorine, it is desirable to add an element which is easy to form a binary compound with fluorine and which is 500 kJ/mol or less in free energy per mol of fluoride, such as Co, Al or Cr, to magnetic powder by 0.01 to 5 atomic percent. If the 5 atomic percent is exceeded, the coercive force falls. If the quantity of addition is less than 0.01 atomic percent, the fluorine elimination effect is not perceived. F₂ gas can be used in the fluorine gas processing. Fluorine is introduced into the rare-earth rich phase as well. NdOFₓ (1<X<5) and (Nd, Fe) OFₓ (1<X<5) are formed on a part of grain boundaries. A part of elements such as Al, Zr and Cr having a tendency to link with fluorine distributes unevenly in the vicinity of the acid fluoride together with a heavy rare-earth element as a result of growth of an acid fluoride containing fluorine highly, resulting in increased coercive force. Such uneven distribution of elements added to the sintered magnet is perceived remarkably as to an element having generation free energy of fluoride located on the negative side as compared with Cu. For improving the magnet performance, therefore, it becomes necessary to add an element having generation free energy of fluoride located on the negative side as compared with Cu to the sintered magnet in the range of 0.01 to 5.0 atomic percent. If the fluorine concentration (X) of NdOFₓ is less than 1, uneven distribution in the vicinity of the acid fluoride is not remarkable. If the fluorine concentration (X) of NdOFₓ is at least 5, another fluoride is apt to be formed, the grain diameter of the acid fluoride on the grain boundary becomes large, and the residual magnetic flux density tends to fall.

The Fe—F alloy in the present example has a remanence in the range of 1.6 to 2.5 T. The atomic position of fluorine is an interstitial sites or a substitution position. For fixing a fluorine atom, Co, Al or Cr described above or a rare-earth element is disposed in an iron atomic position. Interstitial elements such as carbon, hydrogen, nitrogen, chlorine, and boron can coexist together with fluorine elements with a lower concentration as compared with fluorine. Crystal containing fluorine is stable up to 900° C. On the higher temperature side than 900° C., it changes to a stable fluoride or acid fluoride.

### EXAMPLE 8

Fluorine is introduced from the surface of a Fe-50% Co grain by fluorine gas processing. The average grain diameter of the Fe-50% Co grain is 20 nm. Fluorine is introduced into a FeCo alloy phase by using a pyrolytic gas of XeF₂ as the fluorine gas. A part of the introduced fluorine and Fe and Co atoms are made regular by introducing fluorine at 150° C. and then conducting heat treatment in a unidirectional magnetic field of at least 10 kOe at 600° C. for ten hours. A FeCoF regular phase has a fluorine concentration in the range of 0.1 to 25 atomic percent, and crystal magnetic anisotropy increases as a result of extension of a lattice in the magnetic field application direction. A bond magnet using an organic binder agent is obtained by molding the grains in the magnetic field.

Furthermore, a compression molded magnet is obtained by conducting provisional molding on the grains before fluorination processing, conducting fluorination processing, and conducting compression molding in a magnetic field. For obtaining coercive force of at least 5 kOe, it is necessary to bring the concentration of fluorine atoms arranged regularly in FeCoF in the range of 5 to 15 atomic percent, add a transition element other than Fe and Co by 0.1 to 20 atomic percent as a fourth additional element, and yield a regular arrangement of the additional element.

Since the remanence of FeCo grains is 2.0 T, a demagnetizing field is great. In general applications, further larger coercive force (at least 10 kOe) is needed. For obtaining such coercive force, it is effective to make the crystal magnetic anisotropy of the FeCoF phase large, and the atomic position of fluorine becomes important. Arrangement is conducted to cause Fe atoms more than Co atoms to become nearest neighbor atoms of fluorine. As a result, unevenness is caused in the electron state density distribution of Fe atoms brought about by fluorine atoms, and crystal magnetic anisotropy energy is increased. Coercive force of 20 kOe is obtained at 20° C. For implementing such an atomic arrangement, it is effective to increase the order of fluorine atoms by causing reaction of interstitial elements such as nitrogen and carbon with XeF₂ decomposition gas.

A magnet material composed of FeCoF alloy phases which differ in value of coercive force is obtained by changing orders of fluorine, Fe, and Co within one body magnet. The order in the complete regular state is taken as 1. A magnet in which the residual magnetic flux density can be changed by an applied magnetic field in a rotating machine or the like is obtained by causing an alloy phase having an order in the range of 0 to 1 to grow in the range of 0.2 to 0.8 in average order.

If the residual magnetic flux density is in the range of 1.0 to 1.7 T in the present example, then heat resistance of the regular phase can be improved by adding transition elements of at least one kind other than Fe, Co and F. In particular, heat resistance in the range of 200 to 300° C. is obtained by adding V, Cr and Mn and a rare-earth element by 0.01 to 10 atomic percent and arranging a part of added elements in regular positions.

A pyrolytic gas of HeX₂ can be used for magnetic characteristics improvement (such as magnetization increase, magnetic modification point control, coercive force control, increase of magnetic resistance effect, increase of magnetic cooling effect, superconducting critical temperature rise, and magnetostriction increase) of ferromagnetic materials or magnetic materials of antiferromagnetism and ferrimagnetism, besides the present example. Decomposition gas, radicals or ions of MF₂ or MF₃ (M is an element in 13th family to 18th family other than F) can be used instead of pyrolytic gas of HeX₂. Such a fluorination agent may contain other interstitial elements such as carbon and nitrogen.

### EXAMPLE 9

In a (Nd, Dy)₂Fe₁₄B sintered magnet, Cu, Ga, and Al are mixed with a raw powder before sintering each with a concentration range of 0.01 to 1 atomic percent. It is mixed with powder having a concentration of a rare-earth element which is higher than (Nd, Dy)₂Fe₁₄B. After provisional molding in a magnetic field, the resultant powder is sintered in liquid phase at 1,050° C. This sintered body is immersed in slurry or a colloidal solution with XeF₂ dispersed therein. Fluorine is introduced by fluorine radicals obtained as a result of decomposition of XeF₂ in the temperature range of 100 to 150° C. Fluorine is deposited on grain boundaries in this temperature range. Fluorine is diffused on grain boundaries having a high rare-earth element concentration by aging heat treatment after the introduction of fluorine. An average grain diameter of XeF₂ is in the range of 0.1 to 1,000 μm. If fluorine is diffused on the grain boundaries, then the composition, structure, interface structure, and unevenly distributed elements on grain boundaries and in the vicinity of grain boundaries change largely, and magnetic characteristics of the sintered magnet are improved. The grain boundary phase of a part before the introduction of fluorine is in the range of (Nd, Dy)₂O₃₋ₓ (0<X<3) to (Nd, Dy)ₓO_{y}F_{z} (where X, Y and Z are positive numbers). The Dy concentration in (Nd, Dy)ₓO_{y}F_{z} is smaller than the Dy concentration in (Nd, Dy)₂O₃₋ₓ (0<X<3). In (Nd, Dy)ₓO_{y}F_{z}, the concentration of Nd is greater than the concentration of Dy. This means that Dy in the grain boundary phase distributes unevenly on a periphery side of the main phase. Furthermore, owing to the introduction of fluorine, uneven distribution of added elements such as Ga and Al besides Cu in the vicinity of the interface between the grain boundary phase and the main phase is promoted and the oxygen concentration in the main phase decreases. In addition, a part of Dy in a central part of crystal grains in the main phase is diffused around the grain boundaries and distributed unevenly.

In the demagnetization curve immediately after the introduction of fluorine, components having small coercive force are perceived as a stepwise demagnetization curve. However, components having small coercive force are eliminated from the demagnetization curve by aging heat treatment in the range of 400 to 800° C. The remanence after the fluorine introduction increases in the range of 0.2 to 10% as compared with that before the fluorine introduction. The increase of the remanence causes an increase of the residual magnetic flux density, and the maximum energy product increases as compared with that before the fluorine introduction. It is also possible to remove unreacted fluorine and the like emitted from the sintered magnet, by the aging heat treatment in the range of 400 to 800° C.

As described above, fluorine distributes unevenly on grain boundaries after the introduction of fluorine. Most of the grain boundaries are occupied by fluoride or acid fluoride. Its crystal structure is cubic, orthorhombic, hexagonal, rhombohedral, or amorphous. A part of fluorine diffuses into crystal grains of the main phase other than grain boundaries, and Fe, a FeₓM_{y} alloy, or a FeₕMᵢFⱼ alloy having a bcc or bct structure grows from a part of main phases. Here, M is an element added to a raw powder before sintering or an element diffused from the magnet surface after sintering and before the introduction of fluorine, and x, y, h, i, and j are positive numbers. The fluorine diffused into main phase crystal grains is abundant near the surface of the sintered magnet. Therefore, Fe, the FeₓM_{y} alloy, or the FeₕMᵢFⱼ alloy having the bcc or bct structure is also abundant in the vicinity of the surface than in the center part of the sintered magnet.

The above-described Fe, the FeₓM_{y} alloy, or the FeₕMᵢFⱼ alloy having the bcc or bct structure singly has coercive force in the range of 0.1 to 10 kOe and remanence in the range of 1.6 to 2.1 T. The coercive force is less and the remanence is greater as compared with the case of only (Nd, Dy)₂Fe₁₄B. By magnetically coupling with (Nd, Dy)₂Fe₁₄B, therefore, magnetization reversal is suppressed and a monotonous demagnetization curve is obtained with respect to a step-less demagnetizing field. For making the residual magnetic flux density variable in the range of 0.01 to 0.5 T depending upon the value of the demagnetizing field, the volume rate of the Fe, the FeₓM_{y} alloy, or the FeₕMᵢFⱼ alloy having the bcc or bct structure to the whole sintered magnet is set to be in the range of 10 to 70%. Furthermore, a part of B (boron) in (Nd, Dy)₂Fe₁₄B is replaced by F (fluorine), and (Nd, Dy)₂Fe₁₄(B, F) is formed. Since (Nd, Dy)₂Fe₁₄(B, F) is higher than (Nd, Dy)₂Fe₁₄B in remanence, its residual magnetic flux density can also be made high. It is also possible to raise the crystal magnetic anisotropy energy and the Curie temperature by controlling the atomic position of fluorine.

The introduced fluorine can be confirmed in three phases: grain boundaries, FeM alloy, and (Nd, Dy)₂Fe₁₄(B, F). Its existence ratio is in the range of 80 to 90% in the grain boundaries, in the range of 1 to 20% in the FeM alloy, and in the range of 1 to 5% in (Nd, Dy)₂Fe₁₄(B, F). The existence ratio is the largest in the grain boundaries. Then, the FeM alloy, and the main phase (Nd, Dy)₂Fe₁₄(B, F) follow.

For preventing the residual magnetic flux density from being changed by an external magnetic field, it is necessary to make the volume rate of the Fe, the FeₓM_{y} alloy, or the FeₕMᵢFⱼ alloy having the bcc or bct structure less than 10%. If the volume rate is at least 10%, the residual magnetic flux density can be changed reversibly by an external magnetic field of 5 kOe or less. If the volume rate exceeds 70%, the residual magnetic flux density remarkably lowers. In the variable residual magnetic flux density magnet, therefore, a fluorine introduction processing condition is rationalized to bring the volume rate of the Fe, the FeₓM_{y} alloy, or the FeₕMᵢFⱼ alloy having the bcc or bct structure into the range of 10 to 70%. If the total volume rate of the Fe, the FeₓM_{y} alloy, or the FeₕMᵢFⱼ alloy having the bcc or bct structure is 70% or less, then the coercive force increases by 1 to 10 kOe as compared with that before fluorine is introduced, and the use quantity of the heavy rare-earth element can be reduced remarkably.

In the sintered magnet in the present example, fluorine is diffused mainly to grain boundaries by the introduction of fluorine and the aging heat treatment conducted after the fluorine introduction. As a result, crystal which is greater in saturation magnetization and higher in rare-earth element concentration than the main phase (this phase is referred to as Fe rich phase) grows from the main phase of a part. In the Fe rich phase, a ferromagnetic phase which is a FeRe, FeReM, FeReMF, or FeReMC alloy phase containing a rare-earth element (Re) and which is in the range of 1 to 10 atomic percent in rare-earth element concentration is also perceived besides the above-described Fe, the FeₓM_{y} alloy, or the FeₕMᵢFⱼ alloy having the bcc or bct structure. A phase which exceeds 12 atomic percent in rare-earth element concentration is perceived around such a Fe rich phase. Uneven distribution of the heavy rare-earth element in the peripheral parts of main phase crystal grains adjacent to the Fe rich phase is remarkable. As a result, magnetization reversal in the Fe rich layer and the main phase is prevented by magnetic coupling between them.

In the magnets made under the making condition in the present example, therefore, the sintered magnet which is in the range of 40 to 70 MGOe in maximum energy product and which can be varied in residual magnetic flux density by an external magnetic field has the Nd₂Fe₁₄ phase and the Fe phase as the main phases. The FeRe alloy phase which is lower in rare-earth element concentration than the main phase and a plurality of phases (such as the FeRe phase, fluoride, acid fluoride, boride, carbide, and oxide) which are higher in rare-earth element concentration than the main phase are formed around the main phases. Uneven distribution of the rare-earth element on the peripheral side of the main phase crystal is perceived. The Fe phase which is one of the main phases has a tendency that its ratio increases as the location approaches the surface from the center of the sintered magnet.

The fluorine introduction technique as in the present example can be adopted in rare-earth iron boron sintered magnets such as (Nd, Pr, Dy)₂Fe₁₄B sintered magnets, various magnetic substances such as rare-earth iron boron provisional compact or rare-earth iron boron magnetic powder, rare-earth iron magnetic powder, iron magnetic powder, Alnico magnets, ferrite magnets, manganese magnets, cobalt platinum thin film magnets, iron platinum thin film magnets, and rare-earth boron thin film magnets as well, besides the (Nd, Dy)₂Fe₁₄B sintered magnet. An effect of coercive force increase, remanence increase, premium element use quantity reduction, electric resistance increase, magnetic refrigeration effect increase, magnetic thermoelectric effect increase, magnetic modification point rise, optical magnetic effect increase, or magnetic resistance effect increase is perceived. Especially in the rare-earth iron boron sintered magnet, the fluorine introduction processing in the present example can be applied to magnets made by using a bi-alloy method or the grain boundary diffusion method, magnets made by using an impact compression method or a sputtering method, magnets made by using wet processing, and their processes on the way.

In the material to be processed with fluorine introduced therein as in the present example, the concentration of a rare-earth element is 12% in the main phase and in the range of 30 to 90% in the grain boundary phase. Since there is a great difference in this way, fluorine diffuses into the grain boundary phase selectively. For selectively introducing fluorine by using decomposition-generated fluorine containing radical fluorine in a low temperature area ranging from 20 to 600° C., it is necessary that the element concentration difference among a plurality of constitution phases of the material to be processed is at least 10%. If the element concentration difference is less than 10%, then selective introduction, reaction and diffusion of fluorine are not conducted, but fluorine is introduced to the whole. Therefore, the element concentration difference among a plurality of constitution phases of the material to be processed needs to be in the range of 10 to 100%. If the element concentration difference is 100%, the material becomes a material in which a phase having constituent elements differing from those of the main phase is formed. An element which becomes an object of the element concentration difference among a plurality of constitution phases of the material to be processed is an element (represented by T) which is apt to link with fluorine to form a compound. And it is an element which can form a compound represented by TxFy (where x and y are positive numbers and F is fluorine).

The (Nd, Dy)₂Fe₁₄B sintered magnet in the present example can be applied to surface magnet motors, interior magnet motors, and planer magnet motors. The (Nd, Dy)₂Fe₁₄B sintered magnet in the present example makes it possible to reconcile rare metal use quantity reduction and motor performance improvement.

### EXAMPLE 10

Atomized FeCo powder having an average grain diameter of 20 μm is immersed in a colloidal solution of SmF₃, and a SmF₃ film having an average film thickness of 1 nm is formed on the surface of FeCo powder with an average cover rate of 70%. This powder is immersed in hexane (C₆H₁₄), mixed with a mixture slurry of hexane and xenon fluoride, inserted into a heating furnace filled with Ar gas, and heated to 100° C. The quantity of xenon fluoride is in the range of 1/1,000 to ⅕ with respect to the FeCo powder. If the quantity of xenon fluoride is less than 1/1,000, the quantity of fluorine introduction is small and magnet characteristics are low. If the quantity of xenon fluoride exceeds ⅕, stable fluoride deposits on the surface of the FeCo powder, resulting in lowered magnet characteristics. Xenon fluoride is decomposed at 100° C., and fluorine is introduced into the FeCo powder. The surface of the FeCo powder is subject to deacidification and cleaned by SmF₃, and fluorine can enter a FeCo lattice easily without becoming acid fluoride. After the introduction of fluorine, aging is further conducted at 200° C. to make the atomic arrangement in the crystal of the FeCo powder regular and make a part of fluorine atoms as well regular.

In the FeCo powder in which fluorine is introduced and regular lattices have grown as described above, a FeCo regular phase having fluorine in the range of 5 to 50 atomic percent is perceived and the anisotropic magnetic field becomes 10 to 100 kOe. A bond magnet is obtained by mixing the powder with a binder and then conducting injection molding or compression molding. Furthermore, it is also possible to generate a magnet obtained by conducting compression molding on the powder and impregnating a resultant compact with a solution which becomes an inorganic material. An anisotropic bond magnet can be made by molding in a magnetic field. Since such a bond magnet has Sm in the range of 0.1 to 5 atomic percent, the use quantity of the rare-earth element is small. A magnet in which the residual magnetic flux density is variable in the range of 0.8 to 1.4 T is obtained by mixing FeCo powder in which fluorine is not introduced with FeCo powder in which fluorine is introduced and then conducting molding.

### EXAMPLE 11

In a (Nd, Dy)₂Fe₁₄B sintered magnet, Cu, Zr, Al and Co are mixed with a raw powder before sintering each with a concentration range of 0.1 to 2 atomic percent. It is mixed with powder having a concentration of a rare-earth element which is higher than (Nd, Dy)₂Fe₁₄B. After provisional molding in a magnetic field, the resultant powder is sintered in liquid phase at 1,000° C. This sintered body is immersed in slurry or a colloidal solution with XeF₂ and a Co complex dispersed therein. Fluorine is introduced by fluorine radicals obtained as a result of decomposition of XeF₂ in the temperature range of 30 to 100° C. Fluorine is deposited on grain boundaries in this temperature range. Fluorine and Co are diffused on grain boundaries having a high rare-earth element concentration by aging heat treatment after the introduction of fluorine. An average grain diameter of XeF₂ is in the range of 0.1 to 1,000 μm. If fluorine is diffused on the grain boundaries, then the composition, structure, interface structure, and unevenly distributed elements on grain boundaries and in the vicinity of grain boundaries change largely, and magnetic characteristics of the sintered magnet are improved. The grain boundary phase of a part before the introduction of fluorine is in the range of (Nd, Dy)₂O₃₋ₓ (0<X<3) to (Nd, Dy)ₓO_{y}F_{z} (where X, Y and Z are positive numbers). The Dy concentration in (Nd, Dy)ₓO_{y}F_{z} is smaller than the Dy concentration in (Nd, Dy)₂O₃₋ₓ (0<X<3). In (Nd, Dy)ₓO_{y}F_{z}, the concentration of Nd is greater than the concentration of Dy. This means that Dy in the grain boundary phase distributes unevenly on a periphery side of the main phase. Furthermore, owing to the introduction of fluorine, fluorine is diffused into the grain boundary phase and the main phase, and uneven distribution of added elements such as Co, Al and Zr besides Cu in the vicinity of the interface is promoted and the oxygen concentration in the main phase decreases. In addition, a part of Dy in a central part of crystal grains in the main phase is diffused around the grain boundaries and diffused into parts of grains, and distributed unevenly.

The demagnetization curve immediately after the introduction of fluorine is measured as a stepwise demagnetization curve having distribution in coercive force. However, fluorine and main phase constituting elements are diffused and components having small coercive force are eliminated from the demagnetization curve by aging heat treatment in the range of 400 to 800° C. The remanence after the fluorine introduction increases in the range of 0.2 to 20% as compared with that before the fluorine introduction. The increase of the remanence causes an increase of the residual magnetic flux density, and the maximum energy product increases as compared with that before the fluorine introduction. It is also possible to remove unreacted fluorine and the like emitted from the sintered magnet, by the aging heat treatment in the range of 400 to 800° C.

As described above, fluorine distributes unevenly on grain boundaries after the introduction of fluorine. The grain boundaries in the range of 5 to 90% are occupied by fluoride or acid fluoride. Its crystal structure is cubic, orthorhombic, hexagonal, rhombohedral, or amorphous. A part of fluorine diffuses into crystal grains of the main phase other than grain boundaries and to grain boundary triple points, and Fe, a FeₓM_{y} alloy, or a FeₕMᵢFⱼ alloy having a bcc or bct structure grows from main phases of a part. Here, M is an element added to a raw powder before sintering or an element diffused from the magnet surface after sintering together with the introduction of fluorine, and x, y, h, i, and j are positive numbers. The fluorine diffused into main phase crystal grains is abundant near the surface of the sintered magnet. Therefore, Fe, the FeₓM_{y} alloy, or the FeₕMᵢFⱼ alloy having the bcc or bct structure is also abundant in the vicinity of the surface than in the center part of the sintered magnet. A part of fluorine containing Fe alloy has a lattice constant which is less than that (0.2866 nm) of Fe by 0.01 to 10%, and a part of the fluorine containing phase is perceived within the main phase crystal grains as well.

The above-described Fe, the FeₓM_{y} alloy, or the FeₕMᵢFⱼ alloy having the bcc or bct structure singly has coercive force in the range of 0.1 to 10 kOe and remanence in the range of 1.6 to 2.4 T. The coercive force is less and the remanence is greater as compared with the case of only (Nd, Dy)₂Fe₁₄B. By magnetically coupling with (Nd, Dy)₂Fe₁₄B, therefore, magnetization reversal is suppressed and a monotonous demagnetization curve is obtained unlike the magnetization curve immediately after the introduction of fluorine in which an inflection point is perceived at a magnetic field which is 80% or less of the coercive force, in the second quadrant of the demagnetization curve. For making the residual magnetic flux density variable in the range of 0.01 to 0.5 T depending upon the value of the demagnetizing field, the volume rate of the Fe, the FeₓM_{y} alloy, or the FeₕMᵢFⱼ alloy having the bcc or bct structure to the whole sintered magnet is set to be in the range of 0.1 to 70%.

For preventing the residual magnetic flux density from being changed by an external magnetic field, it is necessary to cause the volume rate of the Fe, the FeₓM_{y} alloy, or the FeₕMᵢFⱼ alloy having a hcp structure or an L10 structure with fluorine entered to grow in the range of 0.1 to 50%. Especially, a regular alloy with fluorine entered therein can be formed by fluorination processing in a magnetic field, heat treatment in a magnetic field after fluorination, or plastic deformation.

In the magnets made under the making condition in the present example, the sintered magnet which is in the range of 40 to 70 MGOe in maximum energy product and which can be varied in residual magnetic flux density by an external magnetic field has the Nd₂Fe₁₄ phase and the FeCo phase as the main phases. A fluorine containing phase is perceived on these main phase grain boundaries and within the main phases. Uneven distribution of the rare-earth element and added elements on a peripheral side of the main phase crystal and in the main phase crystal is perceived. The FeCo phase which is one of the main phases and the fluorine containing phase within the main phases have a tendency that their ratios increase as the location approaches the surface from the center of the sintered magnet.

The fluorine introduction technique as in the present example is applied to Mn magnetic materials, Cr magnetic materials, Ni magnetic materials, and Cu magnetic materials, besides the (Nd, Dy)₂Fe₁₄B sintered magnet. An alloy phase which does not exhibit ferromagnetism before the introduction of fluorine is provided with ferromagnetism or hard magnetism. Owing to the introduction of fluorine, and regulation of fluorine atom positions or regulation of atomic pairs of fluorine and other light elements, fluorine atoms having high electronegativity changes the electron states of adjacent metal elements largely. As a result, anisotropy is caused in distribution of the electron state density, and the alloy phase is provided with ferromagnetism or hard magnetism.

According to the present invention, it is possible to satisfy reduction of the quantity of rare-earth elements used in rare-earth permanent magnets, increase of coercive force, and increase of the maximum energy product, and the quantity of magnets to be used can be reduced, as described in the examples 1 to 11. This contributes to reduction of sizes and weights of various products using magnets.

It should be further understood by those skilled in the art that although the foregoing description has been made on embodiments of the invention, the invention is not limited thereto and various changes and modifications may be made without departing from the spirit of the invention and the scope of the appended claims.

1. A sintered magnet motor comprising a rotor, a stator, and coils, sintered magnets being disposed on the rotor,
each of the sintered magnets comprising a NdFeB phase containing NdFeB crystal, a FeM phase containing FeM crystal (where M is a transition element other than iron and rare-earth elements), and a heavy rare-earth element containing phase containing a heavy rare-earth element,
the heavy rare-earth element containing phase being located between the NdFeB phase and the FeM phase, and
a residual magnetic flux density of each of the sintered magnets being controlled by a magnetic field generated by a coil current.

2. The sintered magnet motor according to claim 1, wherein a magnetic field generated by a coil current is applied in an initial magnetization direction of each of the sintered magnets to exercise control to make a residual magnetic flux density of the sintered magnet small.

3. The sintered magnet motor according to claim 1, wherein a magnetic field generated by a coil current is applied in a direction opposite to an initial magnetization direction of each of the sintered magnets to exercise control to make a residual magnetic flux density of the sintered magnet large.

4. The sintered magnet motor according to claim 2, wherein a magnetic field generated by a coil current is applied in a direction opposite to the initial magnetization direction of each of the sintered magnets to exercise control to make the residual magnetic flux density of the sintered magnet large.

5. The sintered magnet motor according to claim 2, wherein an inclination of magnetization of the FeM phase changes on the basis of application of the magnetic field generated by the coil current.

6. The sintered magnet motor according to claim 3, wherein an inclination of magnetization of the FeM phase changes on the basis of application of the magnetic field generated by the coil current.

7. The sintered magnet motor according to claim 4, wherein an inclination of magnetization of the FeM phase changes on the basis of application of the magnetic field generated by the coil current.

8. The sintered magnet motor according to claim 2, wherein the applied magnetic field generated by the coil current is at least 3 kOe.

9. The sintered magnet motor according to claim 1, wherein a change width of the residual magnetic flux density is in a range of 0.01 to 0.5 T.

10. The sintered magnet motor according to claim 1, wherein coercive force of the sintered magnet is at least 10 kOe.

11. The sintered magnet motor according to claim 1, wherein a volume rate of the FeM phase in the sintered magnet is in a range of 0.1 to 50%.

12. The sintered magnet motor according to claim 1, wherein the FeM phase has magnetic anisotropy.

13. The sintered magnet motor according to claim 1, wherein saturation magnetization of the FeM phase is greater than saturation magnetization of the NdFeB phase.
